(19) United States
(12) Patent Application Publication
(10) Pub. No.: US 2018/0170380 A1
(43) Pub. Date: Jun. 21, 2018

(54) LANE-KEEPING ASSISTANCE DEVICE, MOTOR VEHICLE HAVING SUCH A LANE-KEEPING ASSISTANCE DEVICE, AND A METHOD FOR MONITORING LANE-KEEPING

(71) Applicant: Conti Temic microelectronic GmbH, Nurnberg (DE)

(72) Inventor: Günter Anton Fendt, Schrobenhausen (DE)

(73) Assignee: Conti Temic microelectronic GmbH, Nurnberg (DE)

(21) Appl. No.: 15/898,643

(22) Filed: Feb. 18, 2018

Related U.S. Application Data
(63) Continuation of application No. PCT/DE2016/200282, filed on Jun. 20, 2016.

(30) Foreign Application Priority Data
Aug. 25, 2015 (DE) 10 2015 216 152.8

(51) Int. Cl. B60W 30/12; G06K 9/00; B60W 40/072; G08G 1/16

(52) U.S. Cl. CPC B60W 30/12; G06K 9/00798; B60W 2420/42; G08G 1/167; B60W 40/072

(57) ABSTRACT

A lane-keeping assistance device for monitoring the lane keeping of a motor vehicle includes an evaluation mechanism for evaluating at least one bend of lanes, located in front of the vehicle. The evaluation mechanism predefines a tolerance threshold value, which defines the maximum deviation limit of a transverse deviation of the motor vehicle from the motor vehicle's own lane. The evaluation mechanism is configured to adapt the tolerance threshold value in such a way that the intersection of an adjacent lane by the own lane in the at least one evaluated bend is tolerated.

### CROSS REFERENCE TO RELATED APPLICATION

This application is a continuation of International application No. PCT/DE2016/200282, filed Jun. 20, 2016, which claims priority to German patent application No. 10 2015 216 152.8, filed Aug. 25, 2015, each of which is hereby incorporated by reference.

### TECHNICAL FIELD

The technical field relates generally to a lane-keeping assistance device for monitoring the lane keeping of a motor vehicle, a motor vehicle having such a lane-keeping assistance device, and to a method for monitoring the lane keeping of the motor vehicle.

### BACKGROUND

Lane-keeping assistance devices, also known as Lane Keeping Support (“LKS”), are used to monitor the lane keeping by the vehicle driver. If the vehicle driver unintentionally leaves the lane, a warning is given out. Leaving the lane unintentionally can, by way of example, come about because the driver has fallen asleep or momentarily lost concentration. There are also exceptions, however, where the driver intentionally leaves their lane. The driver may, by way of example, intentionally cut corners, in order to reduce the transverse forces acting on the driver when cornering.

From published patent WO 2011 067 252 A1, which is likely to represent the closest prior art, a method is known for determining an intersection trajectory, allowing a vehicle to cut a bend section of a roadway. Information about the bend section is thereby received and the bend section is divided into at least one bend segment having a segment length and an initial curvature, wherein the bend segment is either a straight segment, a circular arc segment or a bend segment, the curvature of which is a function of an arc length of the bend segment. An intersection trajectory is subsequently determined from the at least one bend segment, so that the intersection trajectory comprises a predetermined placement with respect to a center of the roadway at a particular point of the bend section.

It is desirable to present a lane-keeping assistance device, a motor vehicle and a method, allowing the vehicle driver, when monitoring lane keeping, to have a safe and at the same time tolerant lane course. In addition, other desirable features and characteristics will become apparent from the subsequent summary and detailed description, and the appended claims, taken in conjunction with the accompanying drawings and this background.

### SUMMARY

A lane-keeping assistance device for monitoring the lane keeping of a motor vehicle is proposed. The lane-keeping assistance device preferably comprises at least one vehicle camera for recording at least one image of a surrounding area ahead of the motor vehicle. By way of example, the at least one vehicle camera is intended to be arranged in the passenger compartment behind a windshield in the direction of travel of the motor vehicle.

The lane-keeping assistance device comprises an evaluation mechanism, configured to evaluate lanes located in front of the motor vehicle and at least one bend of lanes located in front of the motor vehicle. In other words, the vehicle lanes and the bends in these ahead of the vehicle in its onward journey are evaluated. The at least one vehicle camera is preferably connected to the evaluation mechanism for conveying the at least one image, wherein the evaluation mechanism is configured to evaluate in particular from the at least one image conveyed the lanes and/or the at least one bend of the lanes. Alternatively, or optionally in addition, it can be provided that the evaluation mechanism evaluates the lanes and/or the at least one bend of the lanes in front utilizing a GPS location and cartographical material.

The evaluation mechanism predefines a tolerance threshold value, which defines the maximum deviation limit of transverse deviation of the motor vehicle from an own lane, thus the lane which the motor vehicle is currently in. To determine an overshooting of the tolerance threshold, by way of example the position of the motor vehicle relative to at least one lane marking of the own lane is evaluated, thus in particular the approaching, reaching and/or exceeding of the lane marking by the motor vehicle. Leaving the own lane is preferably permitted by the lane-keeping assistance device, especially by the evaluation mechanism, should the transverse deviation be evaluated as intentional by the driver, such as for example in a turn signal process.

The lane-keeping assistance device includes in particular a warning mechanism to warn the driver. If the tolerance threshold is exceeded, an acoustic warning message may be emitted to the driver, e.g. a voice message and/or an optical warning message such as, for example, displaying to the driver that the own lane has been left via a display device. Alternatively, or optionally in addition, the evaluation mechanism is configured to impinge on the vehicle dynamics. By way of example, it is provided that an automatic braking action or a steering action of the motor vehicle itself is initiated, so that further incursion into the adjacent lane from the own lane is avoided.

In one exemplary embodiment, the evaluation mechanism is configured to adapt the tolerance threshold value in such a way that the intersection of the adjacent lane by the own lane in the at least one evaluated bend is tolerated. Particularly, the adaptation of the tolerance threshold is temporary, in particular exclusively while travelling a bend area. Intersecting the adjacent lane is in this connection understood to be overshooting of the own lane into the adjacent lane. In particular, the own lane is overshot if the motor vehicle is crossing over or has crossed over a lane marking delimiting the two lanes. The adapted tolerance threshold value allows in particular only with a sub-area of the motor vehicle, e.g. with a maximum of 50 cm, to deviate from the own lane into the adjacent lane, so that a further deviation from the own lane is classified as unintentional deviation.

Through the lane-keeping assistance device, the lane-keeping operation in bend areas is restricted. The more tolerant trajectory in bend areas allows the driver of the motor vehicle to intentionally intersect lanes in bend areas, so that through the resulting lower transverse-acting forces an increase in comfort can be achieved. The adaptation of the tolerance threshold value further prevents a plurality of undesired alarm messages when there is an intentional intersection of lanes. In this way, the possibility of the driver sensing interference and for this reason switching off the lane-keeping assistance device is excluded, or at least reduced. Accordingly, improved safety for the driver and road users can be achieved.

In an exemplary embodiment, the evaluation mechanism is configured to adapt the tolerance threshold value as a function of the bend direction. Since, when intersecting a bend, only on inside bends can the transverse forces be reduced, in the case of right-hand traffic in left-hand bends, the evaluation mechanism is in particular configured to increase the tolerance threshold value in an inside bend, so that the intersection of the adjacent lane in the inside bend is tolerated by the tolerance threshold value. In particular, an adaptation, especially the increase in the tolerance threshold value, takes place on the basis of a defined target threshold value.

In outside bends, in the case of right-hand traffic, the intersection of the adjacent lane in the bend cannot, on the other hand, achieve any reduction in the transverse forces. Thus, an evaluated intersected adjacent lane in an outside bend can be directly attributed to unintentionally leaving the own lane. Against this background, the evaluation mechanism is in particular configured to lower the tolerance threshold value in an outside bend, so that the intersection of the adjacent lane in the outside bend by the tolerance threshold value is prohibited. Thus, in particular, a reduction takes place in the tolerance threshold value on the basis of the defined target threshold value.

The evaluation mechanism may be configured to evaluate signals concerning the fatigue and/or inattention of the driver. The signals are, by way of example, generated by the detection of an unusual steering operation or by letting go of the steering wheel. In a possible configuration, when these signals are evaluated the tolerance threshold value is adapted by the evaluation mechanism in such a way that the intersection of the adjacent lane in the bend is prohibited by the tolerance threshold value.

It is also possible that the evaluation mechanism is configured to evaluate oncoming traffic such as, for example, automobiles or trucks in the adjacent lane. When evaluating the oncoming traffic in the adjacent lane, the tolerance threshold value is preferably adapted by the evaluation mechanism in such a way that cutting the corner of the adjacent lane is prohibited by the tolerance threshold value. In this way, if there is a deviation towards the adjacent lane a potential collision can be indicated, or the vehicle dynamics actively impinged upon to prevent a collision.

It is further possible that the tolerance threshold value is adapted by the evaluation mechanism in such a way that the intersection of the adjacent lane is prohibited by the tolerance threshold value if oncoming traffic cannot be evaluated by the evaluation mechanism due to an invisible bend. In this way, the intention is that if there is a deviation towards the adjacent lane a potential collision with unknown oncoming traffic can be indicated.

In a possible implementation, the driver assistance device comprises at least or precisely one optical sensor unit such as, for example, a vehicle camera for detection of the surrounding area to the rear of the actual motor vehicle. The evaluation mechanism may be configured to evaluate, from the surrounding area to the rear of the motor vehicle detected by the optical sensor unit, a motor vehicle overtaking the motor vehicle itself. It may be preferred that the tolerance threshold value when the overtaking motor vehicle is being evaluated by the evaluation mechanism is adapted in such a way that intersection with the adjacent lane is prohibited by the tolerance threshold value.

A further object relates to a motor vehicle with a lane-keeping assistance device for monitoring the lane keeping according to the above description.

The disclosure further relates to a method for monitoring lane keeping comprising a lane-keeping assistance device according to the above description. In a first step, at least one bend in lanes ahead of the motor vehicle is evaluated. The lanes ahead are the vehicle's own lane, and thus the lane in which it is currently located, and at least one lane adjacent to the own lane. The evaluation mechanism specifies a tolerance threshold value, which determines the maximum deviation limit of the transverse deviation of the motor vehicle from its lane. In a next step, for a bend ahead the tolerance threshold value is adapted in such a way that the intersection of the adjacent lane by the own lane is in particular tolerated as a function of the bend direction. According to an exemplary embodiment, the intersection of the adjacent lane is exclusively tolerated for inside bends.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a schematic representation of a motor vehicle with a lane-keeping assistance device;

FIG. 2 is a birds-eye view of the motor vehicle with the lane-keeping assistance device of FIG. 1; and

FIG. 3 is an example of the adaptation of a tolerance threshold value as a function of the bend areas shown in FIG. 2.

### DETAILED DESCRIPTION

Corresponding parts are provided with the same reference numerals in all figures.

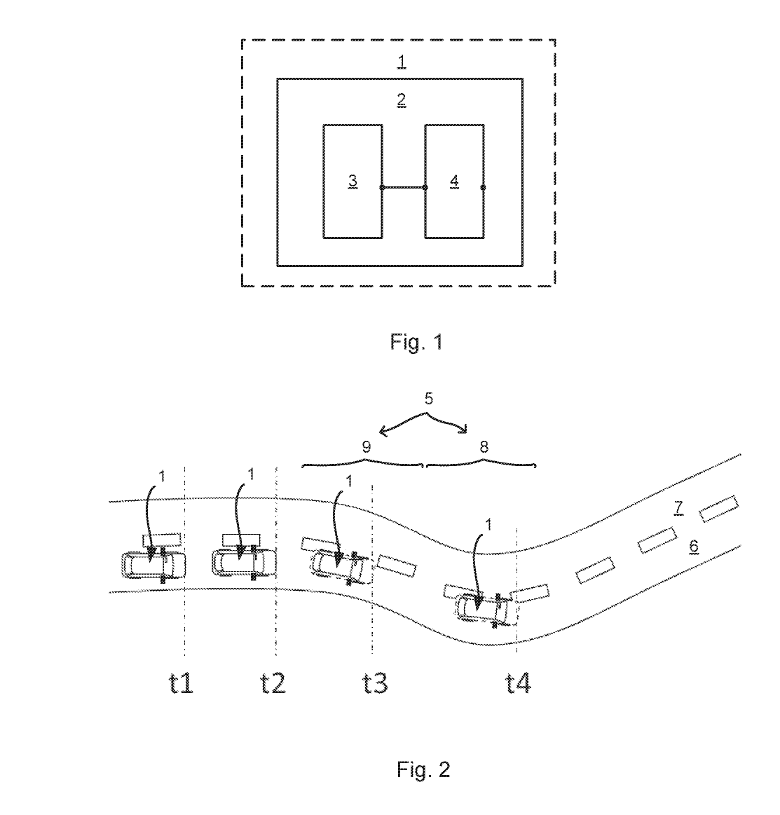

FIG. 1 is a schematic block diagram of a motor vehicle 1 comprising a lane-keeping assistance device 2 for monitoring the lane keeping. The intention is that the driver, utilizing the lane-keeping assistance device 2, is actively and/or passively supported when driving the motor vehicle 1 in its own lane 6.

The lane-keeping assistance device 2 comprises an evaluation mechanism 3, configured to evaluate at least one bend 5 of lanes 6, 7 ahead of the motor vehicle 1. Optionally, the lane-keeping assistance device 2 comprises a vehicle camera 4, which is configured to record at least one image of the area in front of the motor vehicle 1. The vehicle camera 4 is connected to the evaluation mechanism 3 for conveying the at least one captured image, wherein the evaluation mechanism 3 is configured, by utilizing an algorithm, to evaluate the bend in the lanes 6, 7 ahead from the at least one image recorded by the vehicle camera 4.

The evaluation mechanism 3 predefines a tolerance threshold value TW, which defines the maximum deviation limit of a transverse deviation of the motor vehicle 1 from its own lane 6. Thus, by utilizing the tolerance threshold value TW, it is determined whether an unintentional exceeding of the lane by the motor vehicle 1 has taken place. By way of example, the tolerance threshold value TW determines the permitted limiting value of a deviating relative position of the motor vehicle 1 to an ideal lane center line in its own lane 6. To determine the ideal center line, by way of example the course ahead of the own lane 6 is evaluated. To determine the relative position, for example a distance of the motor vehicle 1 to a lane border or a lane delimiting line of a lane 6, 7 is determined.

The evaluation mechanism 3 is configured to adapt the tolerance threshold value TW in such a way that the intersection of the adjacent lane 7 by the own lane 6 in the at least one evaluated bend 5 is tolerated. Thus, through the tolerance threshold value TW for the evaluated bend 5 it is determined to what extent the motor vehicle 1 may intrude from a subarea of the own lane 6 into the adjacent lane 7. The adjacent lane 7 involves a lane immediately adjacent to the own lane 6. By way of example, the adjacent lane 7 is an oncoming lane or a lane with the same predefined direction of travel as the own lane 6.

The intersection of the adjacent lane 7 is tolerated by the evaluation mechanism 3 exclusively for inside bends 8 and thus excluded for outside bends 9. This has the advantage that the driver is able to intersect with the adjacent lane 7 without a warning message and thus reduce transverse forces. Since the intersection of the adjacent lane 7 in outside bends 9 would not lead to any reduction in the transverse forces, the differentiation between outside and inside bends 8, 9 regarding the error tolerance also achieves the advantage that the intersection in outside bends 9 is evaluated immediately as a driving error and accordingly the lane-keeping assistance device 2 can react to this in good time.

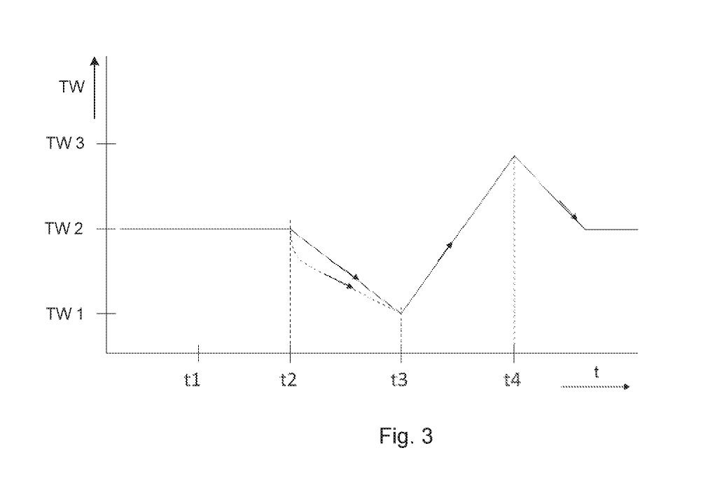

For a more detailed explanation of the lane-keeping assistance device 2, FIG. 2 presents a birds-eye view of the actual motor vehicle 1 driving along an inside and outside bend 8, 9 in its own lane 6. Between time t1 and t2 the motor vehicle 1 can be found on a straight section of lane of the own lane 6. In the interval t1-t2 the tolerance threshold value TW remains unchanged, as also represented in the diagram of FIG. 3. At time t2 the motor vehicle 1 is entering a first bend 5. Since the first bend 5 involves an outside bend 9, from time t2 the tolerance threshold value TW is lowered, so that the intersection of the adjacent lane 7 in the outside bend 9 is prohibited by the tolerance threshold value TW. As shown in FIG. 3 as a possible exemplary embodiment, the tolerance threshold value TW is lowered until time t3, wherein at time t3 the motor vehicle 1 has already entered the outside bend 9. As an exemplary alternative, it can similarly be provided that the tolerance threshold value TW is lowered until the end of the outside bend 9 or already before the outside bend 9 is entered to a maximum value TW1.

The motor vehicle 1 then enters a second bend 5. Since the second bend 5 involves an inside bend 8, from time t3 the tolerance threshold value TW is raised, so that the intersection of the adjacent lane 7 in the inside bend 8 is tolerated by the tolerance threshold value TW. As shown in FIG. 3 as a possible exemplary embodiment, the tolerance threshold value TW is raised until time t4, wherein the motor vehicle 1 at time t4 has already entered the inside bend 8. Here also, as an exemplary alternative, it can be provided that the tolerance threshold value TW is raised until the end of the inside bend 8 or already before entering the inside bend 8 to a maximum value TW3.

Then the motor vehicle 1 travels along a straight section of lane of its own lane 6. As shown by way of example in FIG. 3, the tolerance threshold value TW is adapted to a predefined target threshold value TW2 by the evaluation mechanism 3.

The route forms of FIG. 3 of the adaptation of the tolerance threshold value TW are shown purely by way of example. Thus, the adaptation of the tolerance threshold value TW, apart from the linear and partially exponential routes shown, can similarly, by way of example, take place in stages. The correspondence between the maximum values TW1, TW2 of the tolerance threshold value TW in FIG. 3 and the peaks of the curves of times t3, t4 are shown purely by way of example and should therefore not be understood to be restrictive. Thus, a possible alternative could be envisaged in which the tolerance threshold value TW at the time of entering the bend 5 is adapted to the maximum value TW1, TW3.

### LIST OF REFERENCE NUMERALS

1 Motor vehicle
2 Lane-keeping assistance device
3 Evaluation mechanism
4 Vehicle camera
5 Bend
6 Own lane
7 Adjacent lane
8 Inside bend
9 Outside bend
TW Tolerance threshold value

1. A lane-keeping assistance device for monitoring the lane keeping of a motor vehicle, comprising:
an evaluation mechanism for evaluating at least one bend of lanes located in front of the motor vehicle;
wherein the evaluation mechanism predefines a tolerance threshold value, which defines the maximum deviation limit of a transverse deviation of the motor vehicle from an own lane; and
the evaluation mechanism is configured to adapt the tolerance threshold value in such a way that the intersection of an adjacent lane by the own lane in the at least one evaluated bend is tolerated.

2. The lane-keeping assistance device of claim 1, wherein the evaluation mechanism is configured to tolerate the intersection of the adjacent lane as a function of the bend direction.

3. The lane-keeping assistance device of claim 1, wherein the evaluation mechanism is configured to increase the tolerance threshold value in an inside bend in such a way that the intersection of the adjacent lane in the inside bend is tolerated.

4. The lane-keeping assistance device of claim 1, wherein the evaluation mechanism is configured to lower the threshold value in an outside bend, in such a way that the intersection of the adjacent lane in the outside bend is prohibited by the tolerance threshold value.

5. The lane-keeping assistance device of claim 1, wherein during the evaluation of signals concerning the tiredness and/or inattention of the driver, the tolerance threshold value is adapted in such a way that the intersection of the adjacent lane in the bend is prohibited by the tolerance threshold value.

6. The lane-keeping assistance device claim 1, wherein the evaluation mechanism is configured to evaluate oncoming traffic in the adjacent lane, wherein when oncoming traffic is detected in the adjacent lane, the tolerance threshold value is adapted in such a way that intersection of the adjacent lane is prohibited by the tolerance threshold value.

7. The lane-keeping assistance device of claim 1, wherein the evaluation mechanism is configured to evaluate oncoming traffic in the adjacent lane, wherein the tolerance threshold value is adapted in such a way that intersection of the adjacent lane is prohibited by the tolerance threshold value should it not be possible for the evaluation mechanism to evaluate oncoming traffic due to an invisible bend.

8. The lane-keeping assistance device of claim 1, wherein when evaluating an overtaking motor vehicle, the tolerance threshold value is adapted in such a way that intersection of the adjacent lane is prohibited by the tolerance threshold value.

9. A motor vehicle comprising:
a camera configured to obtain images from an area in front of the motor vehicle; and
an evaluation mechanism in communication with the camera and configured to evaluate the images from the camera for at least one bend of lanes located in front of the motor vehicle,
the evaluation mechanism predefines a tolerance threshold value, which defines the maximum deviation limit of a transverse deviation of the motor vehicle from an own lane; and
the evaluation mechanism is configured to adapt the tolerance threshold value in such a way that the intersection of an adjacent lane by the own lane in the at least one evaluated bend is tolerated.

10. A method for monitoring the lane keeping of a motor vehicle having a lane-keeping assistance device, the method comprising:
evaluation of at least one bend of lanes located in front of the motor vehicle;
predefining a tolerance threshold value, which defines the maximum deviation limit of a transverse deviation of the motor vehicle from an own lane; and
adapting the tolerance threshold value in such a way that the intersection of an adjacent lane by the own lane in the at least one evaluated bend is tolerated.
